(19) United States
(12) Patent Application Publication
(10) Pub. No.: US 2023/0394516 A1
(43) Pub. Date: Dec. 7, 2023

(54) FEDERATED LEARNING MARKETPLACE

(71) Applicant: UNIVERSITY OF SOUTHERN CALIFORNIA, Los Angeles, CA (US)

(72) Inventors: Jose Luis AMBITE MOLINA, Hermosa Beach, CA (US); Dimitrios STRIPELIS, Los Angeles, CA (US)

(73) Assignee: UNIVERSITY OF SOUTHERN CALIFORNIA, Los Angeles, CA (US)

(21) Appl. No.: 18/132,021

(22) Filed: Apr. 7, 2023

Related U.S. Application Data
(60) Provisional application No. 63/349,827, filed on Jun. 7, 2022.

(51) Int. Cl. G06Q 30/0207; G06N 3/098

(52) U.S. Cl. CPC G06Q 30/0215; G06N 3/098

(57) ABSTRACT

A federated learning environment includes a central coordinator that is responsible to orchestrate execution of the federated learning environment, and a plurality of clients jointly that trains machine learning and deep learning models on client computing devices without sharing their local private datasets. The clients only share their locally trained model parameters with the central coordinator. Model parameters are encrypted before sharing with the controller. The central coordinator aggregates local models and computes a new global model in encrypted space. This process repeats for a number of synchronization periods or asynchronously until specific convergence criteria are met. A federated learning marketplace is established to incentivize data providers to join federations through a revenue-sharing model, and to facilitate the use of machine-learning models to organizations outside of the federation.

### CROSS-REFERENCE TO RELATED APPLICATIONS

This application claims the benefit of U.S. provisional application Ser. No. 63/349,827 filed Jun. 7, 2022, the disclosure of which is hereby incorporated in its entirety by reference herein.

### STATEMENT REGARDING FEDERALLY SPONSORED RESEARCH OR DEVELOPMENT

The invention was made with Government support under Contract No. HR00112090104 awarded by the Defense Advanced Research Projects Agency (DARPA). The Government has certain rights to the invention.

### TECHNICAL FIELD

In at least one aspect, the present invention relates to a federated learning environment and marketplace for training and providing machine learning, and in particular deep learning models, for inference.

### BACKGROUND

Machine and deep learning techniques have become widespread in a number of diverse fields. In particular, these techniques are being used in biomedical and healthcare applications. Successful application of these techniques requires the acquisition of sufficiently large training sets that may be difficult to obtain.

Accordingly, there is a need for improved methods of implementing and providing trained machine and deep learning models to users.

### SUMMARY

In at least one aspect, a federated learning marketplace is provided. The federated learning marketplace includes a central coordinator that is responsible to orchestrate the execution of the federated learning environment, and a plurality of clients that jointly train machine learning and deep learning models (i.e., federated models) on client computing devices without sharing their local private datasets. The clients only share their locally trained model parameters with the central coordinator. The central coordinator aggregates local models and computes a new global model. This process repeats for a number of synchronization periods until specific convergence criteria are met. The federated learning marketplace also includes a plurality of model consumers that are provided licenses to use trained machine learning and deep learning models. Advantageously, the central coordinator is configured to receive a first revenue stream from the plurality of clients and a second revenue stream from the plurality of model consumers.

In another aspect, at least a portion of collected fees from model consumers are distributed to clients that contributed to training of a machine learning and deep learning model that is used by model consumers.

In another aspect, the first revenue stream includes an annual license fee that enables clients to form or join coalitions/federations and collaboratively train the machine learning and deep learning models on their own private datasets.

In another aspect, clients that have contributed to the training of any federated model have free access to this specific model for lifetime.

In another aspect, the central coordinator orchestrates the execution of the federated learning marketplace with a coordinator computing device.

In another aspect, the coordinator computing device is configured to aggregate the local models and compute the new global model.

In another aspect, the local models are encrypted before transmission to the coordinator and these models are aggregated in encrypted space using secure aggregation methods.

In another aspect, the federated learning marketplace is configured to distribute training of machine learning and deep learning models by allowing geographically distributed institutions to establish federated coalitions, the federated learning marketplace providing a synergy between model owners, model provider and model consumers synergy between the model owners, model providers, and model consumers.

In another aspect, the federated learning marketplace is established for biomedical, life sciences, and healthcare domains.

In another aspect, once a federated model has been trained, it is stored in a model repository for versioning, bookkeeping, and serving.

In another aspect, any institution that wants to use an already trained federated model to perform predictions over its own private or any other public dataset and has not contributed to its training, needs to pay a corresponding model serving fee.

In another aspect, a revenue sharing model is established so that the sites that contributed data and resources to train a federated model receive a share of the revenues obtained from users of that model as further incentive to participate in the federation, creating an expanding, virtuous cycle of participation.

In another aspect, a federated learning marketplace includes a model repository configured to store trained machine learning and deep learning models and one or more servers configured to distribute training of machine learning and the deep learning models and to store the trained machine learning and the deep learning models

In another aspect, the federated learning marketplace further includes federated coalitions that include geographically distributed institutions.

In another aspect, the federated learning marketplace is configured to provide a synergy between model owners, model providers, and model consumers.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

For a further understanding of the nature, objects, and advantages of the present disclosure, reference should be made to the following detailed description, read in conjunction with the following drawings, wherein like reference numerals denote like elements and wherein:

FIG. 1. Schematic of a federated learning environment.

FIG. 2. Schematic showing model owners, provider and consumers synergy.

FIG. 3. Schematic of a federated learning marketplace business model.

FIG. 4. Block diagram of a computing device that can be used in the federated learning environment.

### DETAILED DESCRIPTION

Reference will now be made in detail to presently preferred embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

When referring to a numerical quantity, in a refinement, the term “less than” includes a lower non-included limit that is 5 percent of the number indicated after “less than.” A lower non-includes limit means that the numerical quantity being described is greater than the value indicated as a lower non-included limited. For example, “less than 20” includes a lower non-included limit of 1 in a refinement. Therefore, this refinement of “less than 20” includes a range between 1 and 20. In another refinement, the term “less than” includes a lower non-included limit that is, in increasing order of preference, 20 percent, 10 percent, 5 percent, 1 percent, or 0 percent of the number indicated after “less than.”

The term “one or more” means “at least one” and the term “at least one” means “one or more.” The terms “one or more” and “at least one” include “plurality” as a subset.

The term “substantially,” “generally,” or “about” may be used herein to describe disclosed or claimed embodiments. The term “substantially” may modify a value or relative characteristic disclosed or claimed in the present disclosure. In such instances, “substantially” may signify that the value or relative characteristic it modifies is within ±0%, 0.1%, 0.5%, 1%, 2%, 3%, 4%, 5% or 10% of the value or relative characteristic.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

The term “computing device” generally refers to any device that can perform at least one function, including communicating with another computing device. In a refinement, a computing device includes a central processing unit that can execute program steps and memory for storing data and a program code.

The term “server” refers to any computer or computing device (including, but not limited to, desktop computer, notebook computer, laptop computer, mainframe, mobile phone, smart watch, head-mountable unit (e.g., smart-glasses, headsets such as augmented reality headsets, virtual reality headsets, mixed reality headsets, and the like), hearables, augmented reality devices, virtual reality devices, mixed reality devices, and the like), distributed system, blade, gateway, switch, processing device, or a combination thereof adapted to perform the methods and functions set forth herein.

When a computing device is described as performing an action or method step, it is understood that the one or more computing devices are operable to or configured to perform the action or method step typically by executing one or more lines of source code. The actions or method steps can be encoded onto non-transitory memory (e.g., hard drives, optical drives, flash drives, and the like).

In an embodiment, a federated learning environment that is used in a federated learning marketplace is provided. In a federated learning environment, N clients (e.g., institutions, sites, learners, parties, silos) jointly train machine learning and deep learning models without sharing their local private datasets. Clients only share their locally trained model parameters (local model) with a central coordinator (federation controller). The coordinator is responsible to orchestrate the execution of the federated environment, aggregate the local models and compute the new global model (community model). This process repeats for a number of synchronization periods (federation rounds) or asynchronously till specific convergence criteria are met.

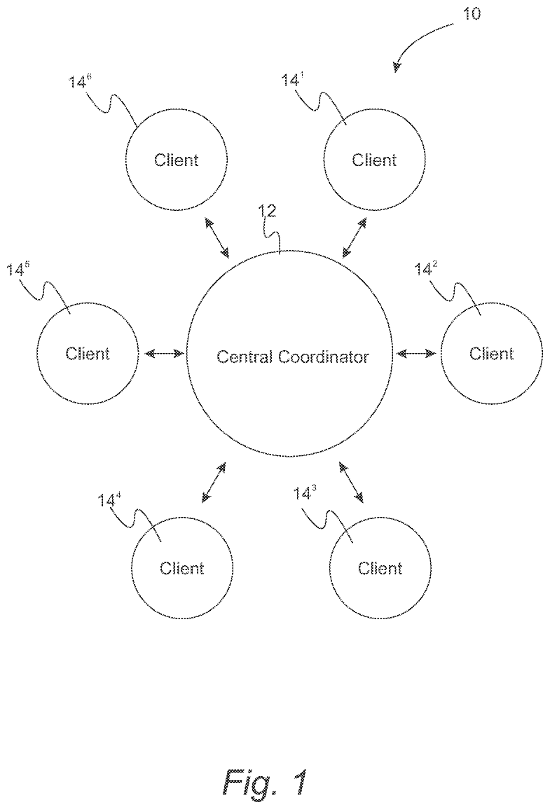

Referring to FIG. 1, federated learning environment 10 includes a central coordinator 12 that is responsible to orchestrate execution of the federated learning environment, and a plurality of clients 14ⁱ (e.g., institutions) that jointly train machine learning and deep learning models (i.e., federated models) on client computing devices without sharing their local private datasets. Parameter i is a positive integer label for each client which runs from 1 to N where N is the total number of clients. In a variation, N is at least 2, 3, 5, 10, or 100. In a refinement, N is from 2 to 1000 or more. In this context, “machine learning and deep learning models” refers to algorithms that are designed to automatically learn from data and make predictions or decisions based on that learning. These models are created by training them on a dataset, and then fine-tuning them to optimize their performance. Examples of machine learning and deep learning models include, but are not limited to, convolutional neural networks, recurrent neural networks, generative adversarial networks, support vector machines, linear regression, logistic regression, decision trees, random forests, and other machine learning algorithms. Typically, each client computing device operates on the same machine learning and deep learning model. In the case of neural networks, clients 14ⁱ can use Stochastic Gradient Descent (SGD) to optimize its local objective on its local dataset. The clients only share their locally trained model parameters with the central coordinator 12. Examples of model parameters for neural network include weights and biases are adjusted during the training process typically by backpropagation. Clients that train models are referred to as model owners. Another set of clients that used trained models are referred to as model consumers.

In another aspect, the coordinator computing device is configured to aggregate the local models and compute the new global model. In this regard, the central coordinator 12 aggregates local models and computes a new (i.e., updated) global model. In a refinement, a global objective function is calculated as a simple average or a weighted average of a local objective function for each client N. For example, a weighted average can weight each local model based on (i.e., proportional to) the number of training examples it was trained on. For neural networks, examples of objective functions include a loss function, cost function, or error function.

The updated parameters for the global model can then be passed to the clients for further optimization. For example, the process repeats for a number of synchronization periods or asynchronously until specific convergence criteria are met. In this context, convergence criteria refer to the conditions under which a machine learning or deep learning algorithm is considered to have “converged” or reached its optimal performance. For example, convergence occurs when the model has learned all the relevant patterns and relationships in the training data, and can no longer improve its performance on the validation or test data. Convergence criteria assist to prevent overfitting. Examples of convergence criteria include loss function and validation accuracy. The loss function measures how well the model is able to predict the output for a given input. Convergence is achieved when the loss function reaches a minimum value or plateaus. The validation accuracy measures how well the model is able to generalize to new, unseen data. In a refinement, convergence is achieved when the validation accuracy reaches a plateau or no longer improves. In a refinement, early stopping can be used to prevent over—fitting by stopping the training process before the model has fully converged. In a further refinement, early stopping is triggered when the validation accuracy or loss function does not improve after a certain number of epochs.

To prevent undesired disclosure of the models to parties outside of the federation, the locally-trained machine learning model of each site is encrypted before transmission to the coordinator. The coordinator aggregates these encrypted site models in encrypted space using secure aggregation methods, such as fully homomorphic encryption, masking, or other methods of secure aggregation.

In another embodiment, a federated learning marketplace is formed. In a variation, the distributed training of machine learning and deep learning models in the biomedical and healthcare domains is streamlined by allowing geographically distributed biomedical institutions (e.g., hospitals, clinics) to establish federated coalitions. Coalitions formation is borderless, cross-continental, cross-country, cross-state.

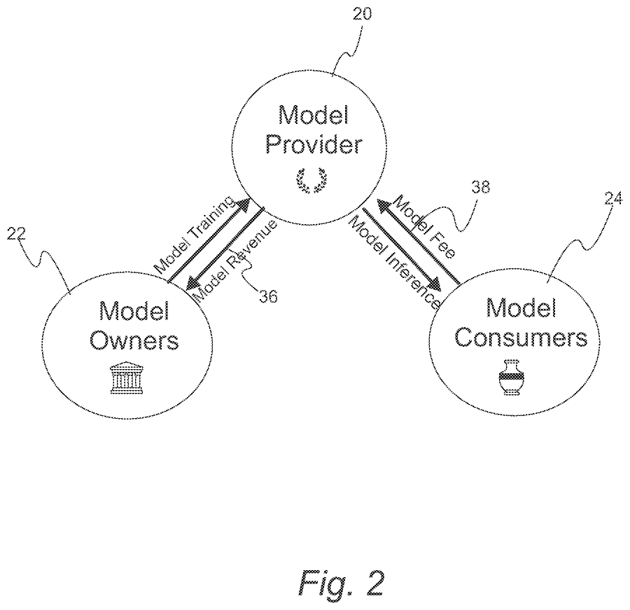

Referring to FIG. 2, a model provider 20 provides the necessary toolset (e.g., Nevron.AI) to automate the formation of these coalitions and enable institutions to train machine learning and deep learning models on their local datasets without ever sharing their local dataset, but their locally trained model parameters; the entire disclosure of the Nevron.AI website is hereby incorporated by reference in its entirety. Once a federated model has been trained, it is stored in the model repository for versioning, bookkeeping, and serving. All institutions that contributed to the training of the federated model have model ownership claims (model owners 22). Any institution (e.g., model consumer 24) that wants to use an already trained federated model to perform predictions over its own private or any other public dataset and has not contributed to its training, needs to pay the corresponding model serving fee. The collected fee is then distributed back to the institutions that contributed to the training of the federated model and to the model provider that enabled the model transaction. This synergy between model owners, model provider (Nevron.AI) and model consumers constitutes the federated learning marketplace.

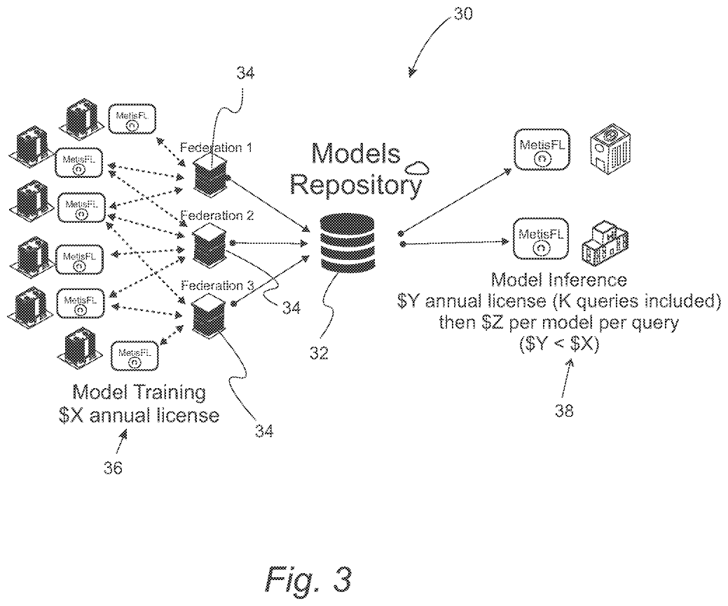

Referring to FIGS. 2 and 3, schematic showing the federated learning marketplace and revenue streams are provided. Federated learning marketplace 30 includes a model repository 32 configured to store trained machine learning and the deep learning models and one or more servers 34 configured to distributed training of machine learning and the deep learning models and to store the trained machine learning and the deep learning models. In a refinement, there are two revenue streams that form the monetization plan of Nevron.AI's federated learning platform, “MetisFL.” The first stream 36 is related to the training of the federated models and the second stream 38 to the federated models serving.

With respect to the first stream, to enable institutions (i.e., clients) to form or join coalitions/federations and collaboratively train machine learning/deep learning models on their own private datasets, every participating institution needs to pay an annual license fee. A secure software package will be installed on-premise for each institution to handle the private training of the federated model on the institution's local dataset and securely exchange encrypted model parameters with the rest of the federation, see left subplot in FIG. 3. Upon completion of the federated model training, every model is stored in the model repository. The model training service package enables formation of federations with other institutions, participation in new or existing federations, participation in the federated model reward system (see model inference below), federated model execution monitoring, secure federated model training, and private federated model training.

Institutions that have contributed to the training of any federated model have free access to this specific model for lifetime. After federated training is completed, a pricing value is assigned to the model. Model price is determined by the quantity and quality of the data, computational resources that each client contributed to training, final learning performance (e.g., accuracy, F1, RMSE, MAE, etc.) of the model, as well as societal/market demand. All institutions that contributed to the training of the final federated model are referred to as federated model owners.

With respect to the second stream, there are institutions that may not be equipped with the necessary computational resources (e.g., no GPU) and/or the necessary type, amount, or quality of data needed to participate in the federated training process. To allow these institutions to gain access via their computing devices to previously trained federated models an annual access license fee that covers the on-premise installation and subscription to the model serving infrastructure is required. Thereafter, the institutions can download and use the federated model on their own premises to perform predictions over their own private or other public datasets. These institutions are referred to as the federated model consumers. The subscription license includes a number of inference queries that can be executed over any federated model at no cost. An inference query is a forward pass over the machine/deep learning model for a single data sample (batch size=1). If the institution exceeds the allocated number of “free” queries, then the cost of every subsequent inference query will be based on the value of the federated model upon which it is executed, i.e., the query price depends on the specifications of the federation (clients) that trained the federated model (see Model Training section). The model inference/serving service package enables access to the federated model's repository and prediction queries over the federated models.

To incentivize more medical institutions to participate in federations and create a fair and self-improving ecosystem, a large proportion of the funds (e.g., 70%) received from the inference queries will be distributed back to the institutions that contributed to the training of the federated models over which the queries were performed. Nevron. AI will receive the remaining to support the marketplace infrastructure. The revenue from a federated model will be shared with the institutions that trained that model in proportion to the amount and quality of data contributed by each institution. For example, for a model that trained over 10,000 subjects, an institution that contributed 2,000 subjects will receive 20% of the revenue.

It should be appreciated that the Nevron.AI MetisFL platform is general and can support arbitrary data types (images, text, structured, multimodal, etc.) and neural architectures (dense, convolutional, recurrent, transformers, etc.). Therefore, it can be applied to other domains beyond biomedicine. Both revenue streams 1 and 2 can be applied to different disciplines, domains, and markets. Geographically distributed financial, manufacturing, or industrial organizations can also form coalitions/federations to jointly train machine/deep learning on their proprietary dataset to improve decision making.

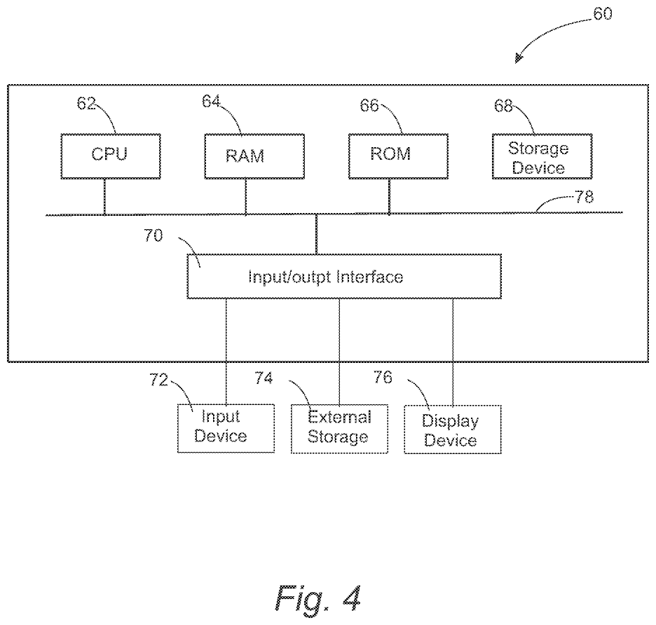

Referring to FIG. 4, a block diagram of a computing device 60 applicable to central coordinator 12, clients 14ⁱ, and servers 34 is provided. Each computing device of computing device includes a processing unit 62 that executes the computer-readable instructions set forth herein. Processing unit 62 can include one or more central processing units (CPU) or micro-processing units (MPU). Computing device 60 also includes RAM 64 and/or ROM 66. Computing device 60 can also include a secondary storage device 68, such as a hard drive. Input/output interface 70 allows interaction of computing device 60 with an input device 72 such as a keyboard and mouse, external storage 74 (e.g., DVDs and CDROMs), and a display device 76 (e.g., a monitor). Processing unit 62, the RAM 64, the ROM 66, the secondary storage device 68, and input/output interface 70 are in electrical communication with (e.g., connected to) bus 78. During operation, Computing device 60 reads computer-executable instructions (e.g., one or more programs) recorded on a non-transitory computer-readable storage medium which can be secondary storage device 68 and or external storage 74. Processing unit 62 executes these reads computer-executable instructions for the computer-implemented methods set forth herein. Specific examples of non-transitory computer-readable storage medium for which executable instructions for computer-implemented methods are encoded onto include but are not limited to, a hard disk, RAM, ROM, an optical disk (e.g., compact disc, DVD), or Blu-ray Disc (BD)™), a flash memory device, a memory card, and the like.

Additional details regarding the implementation of the methods set forth above are found in D. Stripelis et al., Secure Federated Learning for Neuroimaging, arXiv:2205.05249v1, 11 May 2022; the entire disclosure of which is hereby incorporated by reference.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A federated learning marketplace comprising:
a central coordinator that is responsible for orchestrating the execution of the federated learning environment;
a plurality of clients that jointly train machine learning and deep learning models on client computing devices without sharing their local private datasets, the clients only sharing their locally trained model parameters with the central coordinator wherein the central coordinator aggregates local models and computes a new global model and wherein this process repeats for a number of synchronization periods or asynchronously until specific convergence criteria are met; and
a plurality of model consumers that are provided licenses to use trained machine learning and deep learning models, wherein the central coordinator is configured to receive a first revenue stream from the plurality of clients and a second revenue stream from the plurality of model consumers.

2. The federated learning marketplace of claim 1, wherein at least a portion of collected fees from model consumers are distributed to clients that contributed to training of a machine learning and deep learning model that is used by model consumers.

3. The federated learning marketplace of claim 1, wherein the first revenue stream includes an annual license fee that enables clients to form or join coalitions/federations and collaboratively train the machine learning and deep learning models on their own private datasets.

4. The federated learning marketplace of claim 1, wherein clients that have contributed to training of any federated model have free access to this specific model for lifetime.

5. The federated learning marketplace of claim 1, wherein the central coordinator orchestrates the execution of the federated learning marketplace with a coordinator computing device.

6. The federated learning marketplace of claim 5, wherein the coordinator computing device is configured to aggregate the local models and compute the new global model.

7. The federated learning marketplace of claim 2, wherein the machine learning and deep learning models are selected from the group consisting of convolutional neural networks, recurrent neural networks, generative adversarial networks, linear regression, decision trees, support vector machines, random forests, and other machine learning algorithms.

8. The federated learning marketplace of claim 1 configured to distribute training of machine learning and the deep learning models by allowing geographically distributed institutions to establish federated coalitions, the federated learning marketplace providing a synergy between model owners, model provider and model.

9. The federated learning marketplace of claim 8, wherein the federated learning marketplace is established for biomedical and healthcare domains.

10. The federated learning marketplace of claim 8, wherein once a federated model has been trained, it is stored in a model repository for versioning, bookkeeping and serving.

11. The federated learning marketplace of claim 8, wherein any institution that wants to use an already trained federated model to perform predictions over its own private or any other public dataset and has not contributed to its training, needs to pay a corresponding model serving fee.

12. The federated learning marketplace of claim 8, wherein a revenue sharing model is established so that sites that contributed data and resources to train a federated model receive a share of revenues obtained from users of that model as further incentive to participate in a federation, creating an expanding, virtuous cycle of participation.

13. A federated learning marketplace comprising:
a model repository configured to store trained machine learning and deep learning models; and
a server configured to distributed training of machine learning and the deep learning models and to store trained machine learning and deep learning models, wherein a revenue sharing model is established so that sites that contributed data and resources to train a federated model receive a share of revenues obtained from users of that model as further incentive to participate in a federation, creating an expanding, virtuous cycle of participation.

14. The federated learning marketplace of claim 13 further comprising federated coalitions that include geographically distributed institutions.

15. The federated learning marketplace of claim 13 configured to provide a synergy between model owners, model provider and model consumers synergy.

16. The federated learning marketplace of claim 13, wherein the federated learning marketplace is established for biomedical and healthcare domains.

17. The federated learning marketplace of claim 13, wherein once a federated model has been trained, it is stored in the model repository for versioning, bookkeeping, and serving.

18. The federated learning marketplace of claim 13, wherein any institution that wants to use an already trained federated model to perform predictions over its own private or any other public dataset and has not contributed to its training, needs to pay a corresponding model serving fee.

19. The federated learning marketplace of claim 13, wherein the machine learning and deep learning models are selected from the group consisting of convolutional neural networks, recurrent neural networks, generative adversarial networks, support vector machines, linear regression, logistic regression, decision trees, random forests, and other machine learning algorithms.
